(19) United States
(12) Patent Application Publication
(10) Pub. No.: US 2018/0123411 A1
(43) Pub. Date: May 3, 2018

(54) ROTOR, ROTARY ELECTRIC MACHINE, METHOD OF MANUFACTURING ROTOR, AND ROTOR MANUFACTURING APPARATUS

(71) Applicants: KYB Corporation, Tokyo (JP); TOP Co., Ltd., Echizen-shi, Fukui (JP)

(72) Inventors: Takayuki KAWAGUCHI, Kanagawa (JP); Junya OKABE, Akita (JP); Yoshiteru KUROKAWA, Kanagawa (JP); Hiroyuki MIYOSHI, Fukui (JP); Akihiro KAWABATA, Fukui (JP)

(73) Assignees: KYB Corporation, Tokyo (JP); TOP Co., Ltd., Echizen-shi, Fukui (JP)

(21) Appl. No.: 15/575,879

(22) PCT Filed: Jun. 29, 2016
(86) PCT No.: PCT/JP2016/069301

§ 371 Date: Nov. 21, 2017

(30) Foreign Application Priority Data
Jul. 21, 2015 (JP) 2015-144214

(51) Int. Cl. H02K 1/27; H02K 15/03; H02K 1/26; H02K 15/02; H02K 1/28; H02K 23/04

(52) U.S. Cl. CPC H02K 1/276; H02K 15/03; H02K 1/26; H02K 29/08; H02K 1/28; H02K 23/04; H02K 15/026

(57) ABSTRACT

The rotor includes the rotor core unit and a single cylindrical rotor cover. The rotor core unit has the rotor core fixed to a rotation axis so as to be able to rotate integrally therewith and a plurality of permanent magnets mounted on the rotor core along a circumferential direction thereof. The single cylindrical rotor cover has the upper surface portion and the bottom portion so as to cover an outer circumference of the rotor core. The upper surface portion is in contact with an outer circumferential edge portion of on one end surface in an axial direction of the permanent magnets. The bottom portion is in contact with at least one of the permanent magnets and the rotor core so that the rotor core unit is held in the axial direction by the upper surface portion and the bottom portion.

### TECHNICAL FIELD

The present invention relates to a rotor, a rotary electric machine, a method of manufacturing a rotor, and a rotor manufacturing apparatus.

### BACKGROUND ART

JP1999-299149A discloses a rotor used in a rotary electric machine. This rotor includes a yoke that has magnets mounted on the outer circumference of the yoke and a cover that covers outer circumferential surfaces of the each magnet. Cutouts are formed in circumferential ends of each magnet. Recesses are formed in an open edge portion of each cover. The recesses of the cover are each locked into cutouts of neighboring magnets, thereby restricting axial and circumferential movements of the cover.

### SUMMARY OF INVENTION

With the foregoing conventional technique, in order to circumferentially fix the cover with respect to the yoke, that is to say, in order to prevent the covers from rotating, the magnets and the cover need to be processed before covering the outer circumferences of the magnets with the cover. This increases complexity of manufacturing processes.

An object of the present invention is to prevent a rotor cover from rotating with ease.

According to one aspect of the present invention, a rotor includes: a rotor core unit having a rotor core fixed to a rotation axis to be able to rotate integrally therewith and a plurality of permanent magnets mounted on the rotor core along a circumferential direction thereof; and a single cylindrical rotor cover having a first holding portion and a second holding portion so as to cover an outer circumference of the rotor core. The first holding portion is in contact with an outer circumferential edge portion positioned on one end surface in an axial direction of the permanent magnets. The second holding portion is in contact with at least one of another end surface in the axial direction of the permanent magnets and the rotor core so that the rotor core unit is held in the axial direction by the first holding portion and the second holding portion.

### BRIEF DESCRIPTION OF DRAWINGS

FIG. 1 is a cross-sectional view of a rotary electric machine including a rotor according to an embodiment of the present invention;

FIG. 2 is a perspective view of the rotor according to the embodiment of the present invention;

FIG. 3 is a cross-sectional view of the rotor taken along a line A-A in FIG. 1, showing a plane including a rotation axis of a shaft;

FIG. 4 is a cross-sectional view of the rotor taken along the line A-A in FIG. 1, showing the rotor in which an axial length of a rotor core is longer than those of permanent magnets;

FIG. 5 is a cross-sectional view of a modified rotor taken along the line A-A in FIG. 1, showing the modified rotor in which the axial length of the rotor core is longer than those of permanent magnets;

FIG. 6 is a view taken from arrow C in FIG. 3;

FIG. 7 is a cross-sectional view taken along a line D-D in FIG. 6;

FIG. 8 is a cross-sectional view taken along a line E-E in FIG. 6;

FIG. 9 is a cross-sectional view of the rotor in which the axial length of the rotor core is shorter than those of permanent magnets;

FIG. 10 is a configuration diagram of a rotor manufacturing apparatus according to the embodiment of the present invention, showing a part of the configuration diagram in cross-section;

FIG. 11 is a perspective view of outer collets used in method of manufacturing the rotor according to the embodiment of the present invention;

FIG. 12 is a perspective view for explaining rotor manufacturing processes, showing a process in which the rotor core is accommodated in a rotor cover;

FIG. 13 is a perspective view for explaining the rotor manufacturing processes, showing a state in which the rotor core that has been accommodated in the rotor cover;

FIG. 14 is a cross-sectional view for explaining the rotor manufacturing processes, showing the rotor core and the rotor cover that have been accommodated in a restricting member;

FIG. 15 is a perspective view for explaining the rotor manufacturing processes, showing a state in which the outer collets and inner collets have been disposed;

FIG. 16 is a plan view for explaining the rotor manufacturing processes, showing a state in which the outer collets and the inner collets have been disposed;

FIG. 17 is a cross-sectional view for explaining the rotor manufacturing processes, showing a state in which the first pressing process has been completed;

FIG. 18 is a plan view for explaining the rotor manufacturing processes, showing the state in which the first pressing process has been completed;

FIG. 19 is a perspective view for explaining the rotor manufacturing processes, showing a state in which the outer collets and the inner collets have been removed after the first pressing process has been completed;

FIG. 20 is a plan view for explaining the second pressing process in the rotor manufacturing processes;

FIG. 21 is a plan view for explaining the rotor manufacturing processes, showing the state in which the second pressing process has been completed;

FIG. 22 is a perspective view for explaining the rotor manufacturing processes, showing a state in which the outer collets have been removed after the second pressing process has been completed;

FIG. 23 is a cross-sectional view for explaining the rotor manufacturing processes, showing a state before performing the first pressing process in a case in which the axial length of the rotor core is longer than those of permanent magnets;

FIG. 24 is a cross-sectional view for explaining the rotor manufacturing processes, showing a state in which the first pressing process has been completed in a case in which the axial length of the rotor core is longer than those of permanent magnets;

FIG. 25 is a cross-sectional view showing a cross-section different from that of FIG. 24 for explaining the rotor manufacturing processes, showing a state in which the first pressing process has been completed in a case in which the axial length of the rotor core is longer than those of permanent magnets;

FIG. 26 is a cross-sectional view for explaining the rotor manufacturing processes, showing a state in which the second pressing process has been completed in a case in which the axial length of the rotor core is longer than those of permanent magnets; and

FIG. 27 is a view of a modification of the present invention, showing a state before forming an upper surface portion of the rotor cover.

### DESCRIPTION OF EMBODIMENTS

The following describes an embodiment of the present invention with reference to the attached drawings.

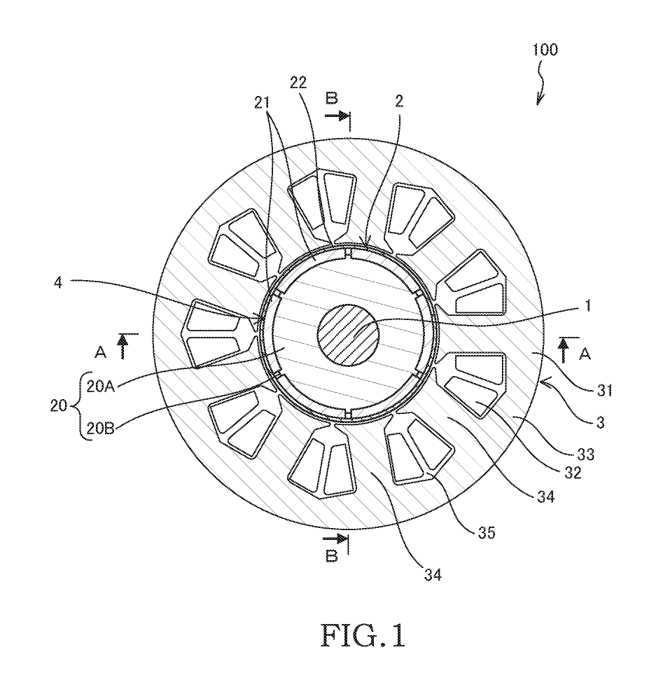

FIG. 1 is a cross-sectional view of a rotary electric machine 100 including a rotor 2 according to the present embodiment, showing a cross-section taken along a direction perpendicular to a rotation axis.

The rotary electric machine 100 functions as at least one of a motor and an electric generator. The rotary electric machine 100, as shown in FIG. 1, includes a rotatable shaft 1 acting as the rotation axis, the rotor 2 fixed integrally to the shaft 1, and a stator 3 that is disposed on an outer circumferential side of the rotor 2 via a predetermined gap.

The rotor 2 includes a rotor core unit 4 and a rotor cover 22 that accommodates the rotor core unit 4.

The rotor core unit 4 includes a rotor core 20 and a plurality of permanent magnets 21. The rotor core 20 is fixed to an outer circumference of the shaft 1 and rotates together with the shaft 1. The plurality of permanent magnets 21 are attached at equal intervals throughout a circumferential direction on an outer circumferential surface of the rotor core 20.

The rotor core unit 4 includes the six permanent magnets 21 that are arranged in the circumferential direction. The rotor core unit 4 is not limited to this, and it may include seven or more permanent magnets or two to five permanent magnets.

The rotor core 20 includes a center part 20A that is provided on an inside of the plurality of permanent magnets 21 and a plurality of projecting portions 20B that project from the center part 20A toward outside in a radial direction of the rotor core 20. The shaft 1 is fixed to the rotor core 20 by being inserted through the center part 20A. The projecting portions 20B are provided at equal intervals in the circumferential direction so as to be respectively disposed between the adjacent permanent magnets 21. That is to say, the permanent magnets 21 are respectively disposed between the adjacent projecting portions 20B so as to be fixed to the center part 20A.

The stator 3 includes an ring-shaped stator core 31 that is arranged so as to surround the rotor 2 with a predetermined gap therebetween and windings 32 that are mounted on the stator core 31.

The stator core 31 includes an annular yoke portion 33, a plurality of teeth 34 that project radially inward from the yoke portion 33 and are arranged at a predetermined interval in the circumferential direction, and slots 35 that are each defined by the adjacent teeth 34 in an inner circumferential side of the yoke portion 33.

The windings 32 are wound around the teeth 34 of the stator core 31, and therefore a coil is formed on each tooth 34. The ends of the windings 32 are connected to an electrode (not shown) of the stator 3. When electric power is supplied to the coils through the electrode, the stator core 31 is magnetized, and an interaction between the stator core 31 and the permanent magnets 21 of the rotor core unit 4 causes the rotor 2 to rotate with the shaft 1 acting as the axis.

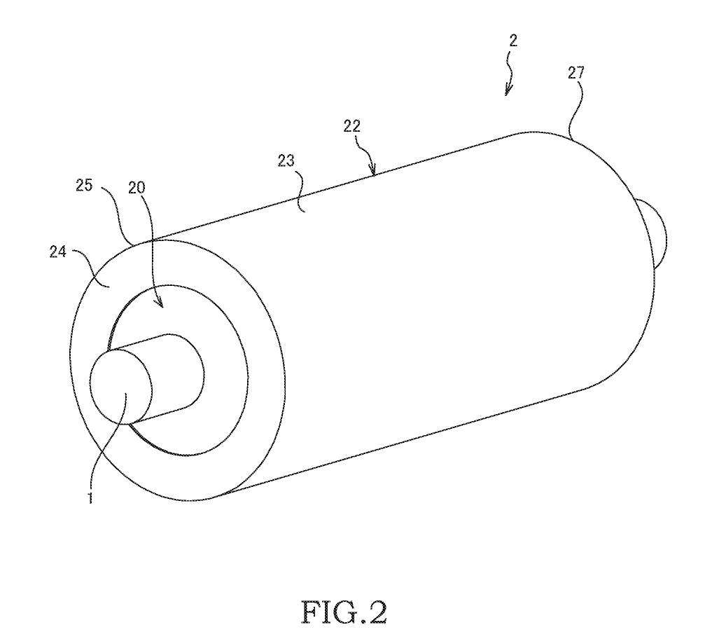

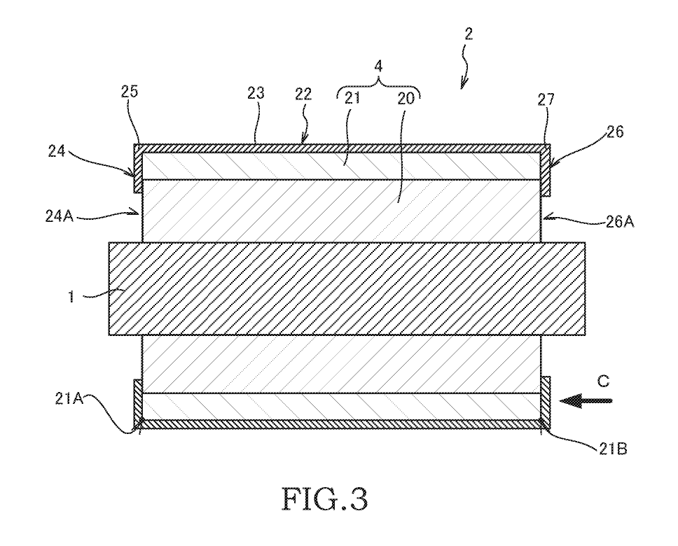

FIG. 2 is a perspective view of the rotor 2 according to the present embodiment. FIG. 3 is a cross-sectional view of the shaft 1 and the rotor 2 taken along a line A-A in FIG. 1.

The rotor cover 22 is made of non-magnetic stainless steel and formed into a shape of a tube with a bottom so as to accommodate the rotor core unit 4 having the rotor core 20 and the permanent magnets 21 that are mounted on the rotor core 20. The rotor cover 22, as shown in FIG. 3, includes a cylindrical portion 23, an upper surface portion 24, and a bottom portion 26. The cylindrical portion 23 covers an outer circumference of the rotor core 20. The upper surface portion 24 serving as a first holding portion is provided on one axial side (the left side in FIG. 3) of the cylindrical portion 23 and is formed by bending the cylindrical portion 23. The bottom portion 26 serving as a second holding portion is provided on the other axial side (the right side in FIG. 3) of the cylindrical portion 23.

The upper surface portion 24 is formed into a shape of a circular ring that has a surface perpendicular to an axial direction and has a center hole 24A that is larger in diameter than the shaft 1. The upper surface portion 24 has an upper surface corner portion 25 on an outer circumferential end portion. The upper surface corner portion 25 is formed between one end portions of the cylindrical portion 23 and the upper surface portion 24, and is in contact with an outer circumferential edge portion 21A that is positioned on one axial end surface of the permanent magnet 21.

The bottom portion 26, as shown in FIG. 3, is formed into a shape of a circular ring that has a surface perpendicular to the axial direction and has a center hole 26A that is larger in diameter than the shaft 1. The bottom portion 26 faces the other end surfaces of the permanent magnets 21 and is in contact with the other end portion of at least one of the rotor core 20 and the permanent magnet 21 of the rotor core unit 4. The bottom portion 26 has a bottom corner portion 27 on the outer circumferential end portion. The bottom corner portion 27 is formed between the other end portion of the cylindrical portion 23 and the bottom portion 26. The actual configuration of the bottom portion 26 will be described in detail later.

The upper surface portion 24 is formed by pressing the one axial end (the left side in FIG. 3) of the cylindrical portion 23 radially inward. Accordingly, the upper surface corner portion 25 is formed so as to be in contact with the outer circumferential edge portion 21A on the one end surface of the permanent magnet 21. The rotor core unit 4 is held in the axial direction with a predetermined force by the upper surface corner portion 25 of the upper surface portion 24 and the bottom portion 26. The upper surface corner portion 25 is in contact with the outer circumferential edge portion 21A positioned on one end surface of the permanent magnet 21. The bottom portion 26 is in contact with the other end portion of at least one of the rotor core 20 and the permanent magnet 21. This increases a frictional force between the rotor cover 22 and the rotor core unit 4 so that a circumferential relative rotation between the rotor cover 22 and the rotor core unit 4 is restricted.

Note that the upper surface corner portion 25 may only be in contact with a part of the entire circumference of the outer circumferential edge portion 21A that is positioned on one axial end surface of the permanent magnet 21. In order to more securely restrict a rotation of the rotor cover 22, it is desirable that the upper surface portion 24 is in contact with an end surfaces of one axial side of the rotor core 20 and the permanent magnets 21 so as to increase the frictional force. However, at least the upper surface corner portion 25 may be in contact with the outer circumferential edge portion 21A. That is to say, there may be a gap between other parts than the upper surface corner portion 25 in the upper surface portion 24 and the rotor core unit 4.

The hole 24A of the upper surface portion 24 and the hole 26A of the bottom portion 26 are formed to have an inner diameter smaller than an outer diameter of the center part 20A of the rotor core 20. The upper surface portion 24 and the bottom portion 26 are extendedly formed to cover both axial end surfaces of the permanent magnet 21.

Next, the upper surface corner portion 25, the bottom portion 26, and the bottom corner portion 27 are described in detail.

Even when the rotor core 20 and the permanent magnet 21 are intended to be formed to have the same axial length, respective axial lengths may vary within a range of dimensional tolerance. In this way, axial lengths of the rotor core 20 and the permanent magnet 21 may differ from each other.

In contrast, even when the axial length of the rotor core 20 is longer than, shorter than, or equal to that of the permanent magnets 21, the upper surface portion 24 and the bottom portion 26 are formed on the rotor cover 22. The upper surface portion 24 includes the upper surface corner portion 25 that is in contact with the outer circumferential edge portion 21A of the permanent magnet 21. The bottom portion 26 is in contact with at least one of the other end surface of the permanent magnet 21 and the rotor core 20. As a result, the circumferential relative rotation between the rotor core unit 4 and the rotor cover 22 of the rotor 2 can be restricted. In other words, regardless of the dimensional relationship of the axial lengths of the rotor core 20 and the permanent magnet 21, a rotation of the rotor cover 22 can be restricted by holding the rotor core unit 4 in the axial direction by the upper surface portion 24 and the bottom portion 26.

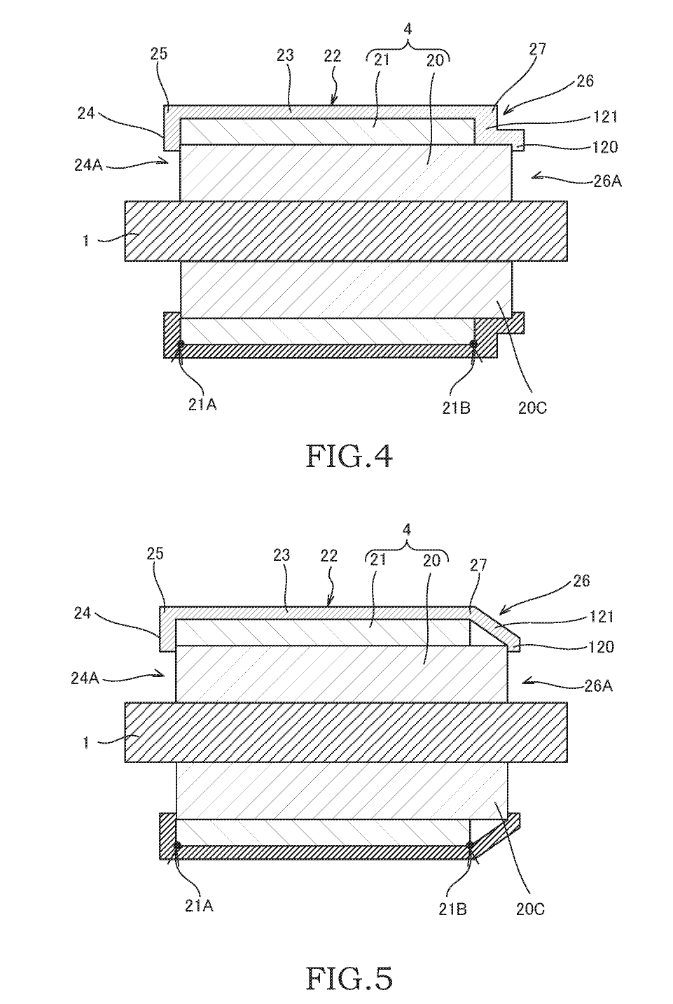

FIG. 4 is a cross-sectional view taken along the line A-A in FIG. 1, showing a state in which the axial length of the rotor core 20 is longer than that of the permanent magnet 21. As shown in FIG. 4, when the axial length of the rotor core 20 is longer than that of the permanent magnet 21, the rotor core 20 includes a protruding portion 20C that protrudes in the axial direction from the other end surface of the permanent magnet 21. The protruding portion 20C is constituted of a part of the center part 20A that protrudes in the axial direction from the other end surface of the permanent magnet 21 and a part of the projecting portions 20B. The bottom portion 26 of the rotor cover 22 includes a core contact portion 120 that is in contact with a bottom surface (an end surface of the protruding portion 20C) of the rotor core 20 and a connecting portion 121 that connects the core contact portion 120 with the bottom corner portion 27.

The connecting portion 121, as shown in FIG. 4, may be in contact with the outer circumferential surface of the rotor core 20 and the other end surface of the permanent magnet 21 in the axial direction, or may be separated from the surfaces, as shown in FIG. 5. In both cases, the upper surface corner portion 25 is in contact with the outer circumferential edge portion 21A that is positioned on the one axial end surface of the permanent magnet 21, and the bottom portion 26 is in contact with at least the protruding portion 20C of the rotor core 20. Thereby, since the rotor core unit 4 is held in the axial direction, a rotation of the rotor cover 22 can be restricted. As shown in FIG. 4, in the case that the connecting portion 121 is in contact with the outer circumferential surface of the rotor core 20 and the other end surface in the axial direction of the permanent magnet 21, and that the bottom corner portion 27 is in contact with an outer circumferential edge portion 21B on the other end surface of the permanent magnet 21, the frictional force is increased so as to be able to more securely restrict a rotation of the rotor cover 22.

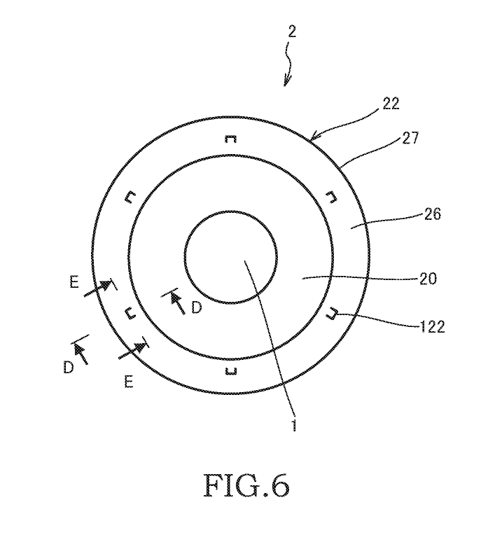

FIG. 6 is a view taken from arrow C in FIG. 3 and is a plan view showing the bottom portion 26 of the rotor cover 22. In the case that the axial length of the rotor core 20 is longer than that of the permanent magnet 21, as shown in FIG. 6, recessed portions 122 that cover part of the projecting portions 20B constituting the protruding portion 20C of the rotor core 20 are provided on the bottom portion 26 of the rotor cover 22.

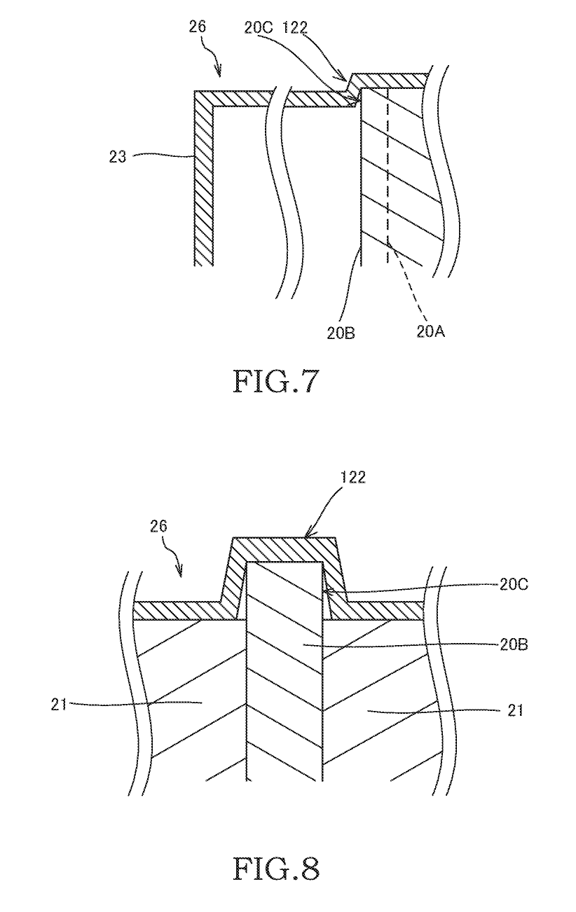

FIG. 7 is a cross-sectional view taken along a line D-D in FIG. 6. FIG. 7 schematically illustrates a boundary between the projecting portions 20B and the center part 20A on the rotor core 20 by a broken line. FIG. 8 is a cross-sectional view taken along a line E-E in FIG. 6.

As shown in FIGS. 7 and 8, the recessed portions 122 are formed such that an inner side thereof (an inner side of the rotor cover 22) in the axial direction are recessed along an outer circumferential edge portion on an end part of the protruding portion 20C. In this way, parts of the projecting portions 20B constituting the protruding portion 20C are engaged with the recessed portions 122 so as to restrict a circumferential relative rotation (the left and right direction of FIG. 8) between the rotor core 20 and the rotor cover 22. As described above, when the axial length of the rotor core 20 is longer than that of the permanent magnet 21, the rotor core unit 4 is held by the upper surface corner portion 25 of the upper surface portion 24 and the bottom portion 26. In addition, the protruding portion 20C is engaged with the recessed portions 122. Therefore, restriction of the rotation of the rotor cover 22 can be performed more securely.

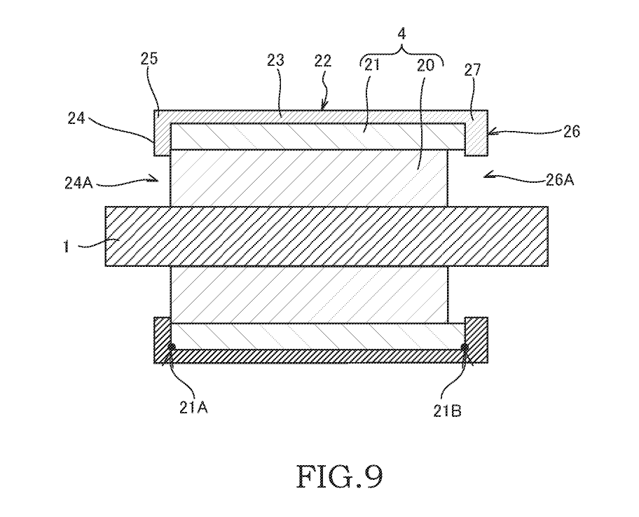

When the axial length of the rotor core 20 is shorter (see FIG. 9) than or equal to (see FIG. 3) that of the permanent magnet 21, the recessed portions 122 are not formed on the bottom portion 26 of the rotor cover 22. As shown in FIG. 9, when the axial length of the rotor core 20 is shorter than that of the permanent magnet 21, the bottom portion 26 of the rotor cover 22 is in contact with the other end surface of the permanent magnet 21 and is formed as an annular plane that is separated from the rotor core 20. In this case, the bottom portion 26 is in contact with the end surface of the permanent magnet 21 and also the bottom corner portion 27 is in contact with the outer circumferential edge portion 21B on the other end surface of the permanent magnet 21 so that the rotor core unit 4 is held by the bottom portion 26 and the upper surface corner portion 25.

As shown in FIG. 3, when the axial length of the rotor core 20 is equal to that of the permanent magnet 21, the bottom portion 26 of the rotor cover 22 is formed as an annular plane that is in contact with both the permanent magnet 21 and the rotor core 20. In this case, the bottom portion 26 is in contact with both the permanent magnet 21 and the rotor core 20 and the bottom corner portion 27 is in contact with the outer circumferential edge portion 21B on the other end surface of the permanent magnet 21 so that the rotor core unit 4 is held by the bottom portion 26 and the upper surface corner portion 25.

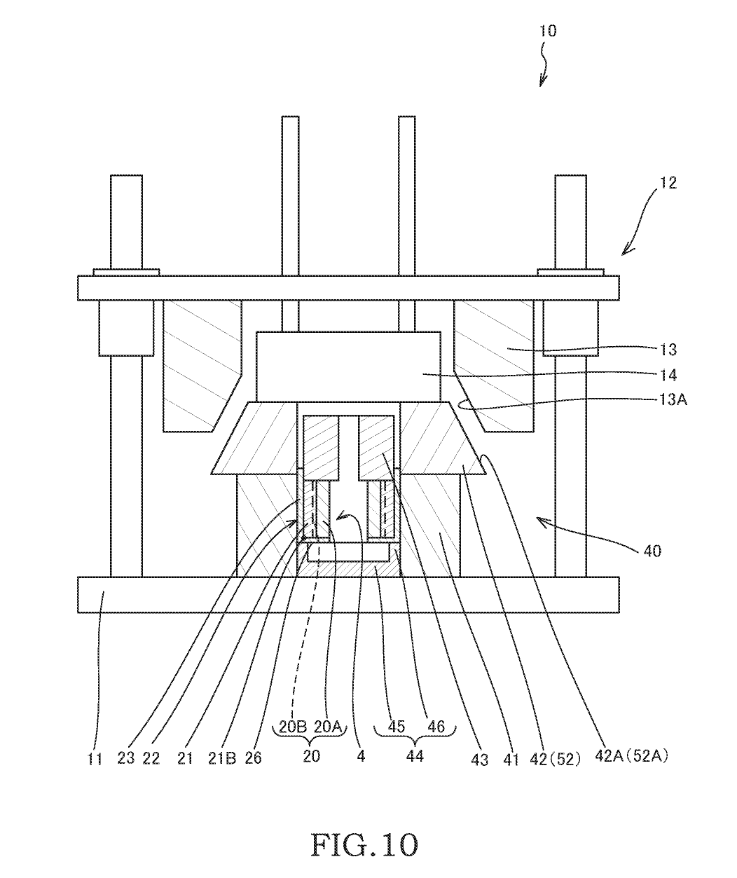

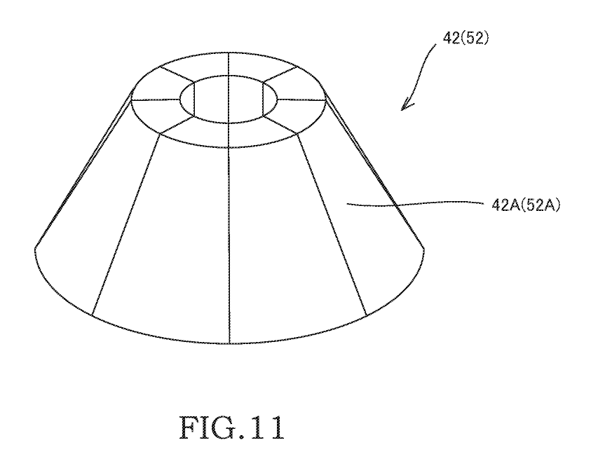

Next, referring mainly to FIGS. 10 and 11, a rotor manufacturing apparatus 10 that manufactures the rotor 2 is described. FIG. 10 is a configuration diagram showing a rotor manufacturing apparatus 10 and is a diagram showing a state before an upper surface portion 24 of the rotor cover 22 is formed.

As shown in FIG. 10, the rotor manufacturing apparatus 10 is a hydraulic press device that forms the upper surface portion 24 of the rotor cover 22 by pressing a mold portion 40 with a slide portion 12 that is driven by hydraulic pressure in a substantially vertical direction. The rotor manufacturing apparatus 10 may be a hydraulic press device of other types or a mechanical press device. The rotor manufacturing apparatus 10 may be a press device that is driven by air pressure.

The rotor manufacturing apparatus 10 includes a bolster 11 that is provided substantially horizontally, the slide portion 12 that moves up and down in the substantially vertical direction relative to the bolster 11, and the mold portion 40 that is placed on the bolster 11 so as to form the upper surface portion 24 of the rotor cover 22 by moving of the slide portion 12.

The slide portion 12 is driven along the substantially vertical direction (upper-lower direction in FIG. 10) relative to the bolster 11 by a driving mechanism (not shown) that transmits hydraulic pressure as a power source. The slide portion 12 has an annular slide contact portion 13 that has, on its inner side, a curved slide tapered surface 13A the diameter of which is increased toward the bottom and that is brought into contact with the mold portion 40. As the slide portion 12 is moved downward by the driving mechanism and the mold portion 40 is pressed through the slide contact portion 13, the upper surface portion 24 of the rotor cover 22 is formed.

The mold portion 40 includes an outer mold 41 serving as a restricting member, a plurality of outer collets serving as a pressing member, a plurality of inner collets 43 serving as a holding member, and a lower die 44. The outer mold 41 is placed on the bolster 11 so as to accommodate the rotor cover 22. The plurality of outer collets press an axial end part of the rotor cover 22 radially inward so as to form the upper surface portion 24. The plurality of inner collets 43 press and hold an inner circumference of the axial end part of the rotor cover 22 radially outwardly. The lower die 44 is placed on the bolster 11 by being accommodated in the outer mold 41 and the rotor cover 22 is placed on the lower die 44.

The outer mold 41 is a cylindrical member an inner diameter of which is set so as to be substantially equal to an outer diameter of the cylindrical portion 23 of the rotor cover 22. The outer mold 41 restricts bulging of the cylindrical portion 23 of the rotor cover 22 outward in the radial direction at the time of depression of the rotor cover 22 as described below.

As described below, the first outer collets 42 are used in the first pressing process of the method of manufacturing the rotor 2 and the second outer collets 52 are used in the second pressing process of the method of manufacturing the rotor 2. The first and the second outer collets 42, 52 are different only in thickness in the radial direction with each other. Therefore, in FIGS. 10 and 11, only the first outer collets 42 are illustrated and the second outer collets 52 are shown by a reference sign in parenthesis.

The first outer collets 42 (the second outer collets 52) are arranged annularly in a circumferentially divided manner and placed on the outer mold 41. As shown in FIG. 11, outer circumferences of the first outer collets 42 (the second outer collets 52) are formed as curved outer tapered surfaces 42A (curved outer tapered surfaces 52A) that is inclined from the center axis so that the outer diameter is increases toward the bottom. The first outer collets 42 (the second outer collets 52) are formed so as to form a truncated cone shape in a state that the adjacent first outer collets 42 (the second outer collets 52) are in contact with each other.

When the slide portion 12 moves downward, the outer tapered surfaces 42A (the outer tapered surfaces 52A) of the first outer collets 42 (the second outer collets 52) are pressed by the slide contact portion 13 downward in FIG. 10 toward the rotor core 20. Therefore, the first outer collets 42 (the second outer collets 52) move radially inward on an upper part of the outer mold 41. Thereby, the first outer collets 42 (the second outer collets 52) press the axial end part of the rotor cover 22 radially inward. The outer circumferential surfaces of the plurality of the first outer collets 42 (the second outer collets 52) may be formed as not curved surfaces but planar pressing tapered planes.

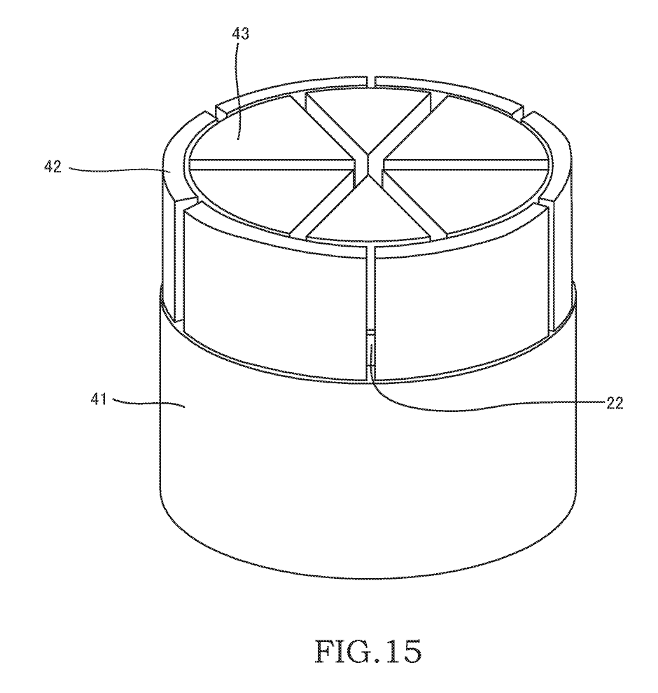

The inner collets 43 are arranged annularly in a circumferentially divided manner so as to be provided at an upper part of the rotor core 20 that is accommodated in the rotor cover 22 (see FIG. 15). The inner collets 43 press the inner circumference of the axial end part of the rotor cover 22 radially outward, thereby holding the rotor cover 22 with the first outer collets 42.

The lower die 44 has an outer diameter that is substantially equal to the inner diameter of the outer mold 41, and is accommodated inside the outer mold 41. The lower die 44 includes a disk-shaped base portion 45, and an annular contact portion 46 that protrudes from the base portion 45 toward the rotor cover 22 in the axial direction and that is in contact with the bottom portion 26 of the rotor cover 22.

The contact portion 46 supports the other end surfaces of the permanent magnets 21 thorough the bottom portion 26 of the rotor cover 22. As shown in FIG. 10, the contact portion 46 has an inner diameter that is larger than an outer diameter of the projecting portions 20B of the rotor core 20, and faces the other end surfaces of the permanent magnets 21 with the bottom portion 26 placed therebetween. An inner space that is provided inside the contact portion 46 faces the rotor core 20 through the bottom portion 26 of the rotor cover 22

The lower die 44 supports the other end surfaces of the permanent magnets 21 through the bottom portion 26 of the rotor cover 22, when the first outer collets 42 (the second outer collets 52) move radially inward to press the axial end part of the rotor cover 22. In this way, the upper surface portion 24 of the rotor cover 22, the permanent magnets 21, and the bottom portion 26 of the rotor cover 22 are held with a predetermined force in the axial direction by the first outer collets 42 (the second outer collets 52) and the lower die 44. The lower die 44 may not have the base portion 45 and may be formed in a cylindrical shape so as to have only the contact portion 46.

As shown in FIG. 10, the rotor manufacturing apparatus 10 further includes a pressing auxiliary member 14 that defines the axial positions of the first outer collets 42 (the second outer collets 52) relative to the rotor core 20.

The pressing auxiliary member 14 is provided vertically movably with respect to the bolster 11 and defines the axial positions of the first outer collets 42 (the second outer collets 52) with respect to the rotor core 20 by being brought into contact with upper surfaces of the first outer collets 42 (the second outer collets 52). The pressing auxiliary member 14 does not move together with the slide portion 12 and is vertically movable relative to the bolster 11 independently. The pressing auxiliary member 14 is a disk-shaped member that is in contact with all of upper surfaces of the plurality of the first outer collets 42 (the second outer collets 52). When the rotor cover 22 is pressed radially inward, the pressing auxiliary member 14 is in contact with the upper surfaces of the first outer collets 42 (the second outer collets 52). Consequently, the first outer collets 42 (the second outer collets 52) are prevented from being separated and lifted in the axial direction from the rotor core 20.

When the first outer collets 42 (the second outer collets 52) press the rotor cover 22 radially inward, the pressing auxiliary member 14 may only support reaction force exerted by the rotor cover 22 and acting on the first outer collets 42 (the second outer collets 52), or the pressing auxiliary member 14 may positively press the first outer collets 42 axially downward against the reaction force exerted by the rotor cover 22. In either case, the pressing auxiliary member 14 define the axial positions of the first outer collets 42 with respect to the rotor core 20.

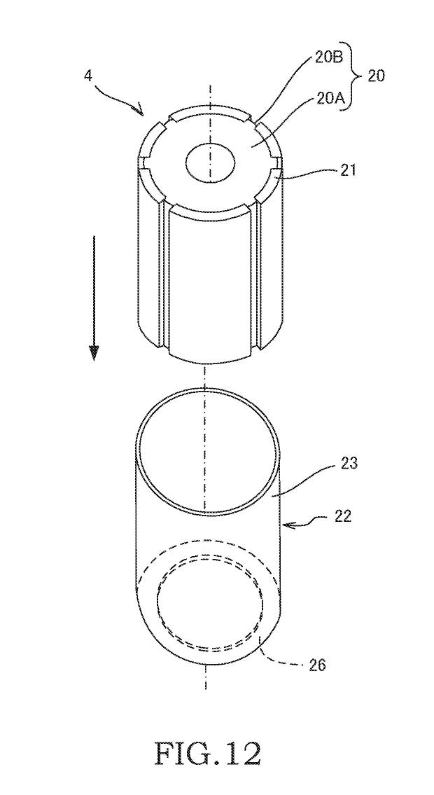

Next, referring to FIGS. 12 to 26, a method of manufacturing the rotor 2 is described. In FIGS. 15, 16, 18, 20, and 21, illustration of the outer tapered surfaces 42A (the outer tapered surfaces 52A) of the first outer collets 42 (the second outer collets 52) is omitted. The following describes, as an example, a case in which the axial length of the rotor core 20 is equal to those of the permanent magnets 21.

Firstly, the rotor core unit 4 is formed by mounting the plurality of permanent magnets 21 on the outer circumferential surface of the rotor core 20. The permanent magnets 21 are mounted between the adjacent projecting portions 20B of the rotor core 20 by using adhesive or the like so as to be arranged at equal intervals along the circumferential direction on the rotor core 20.

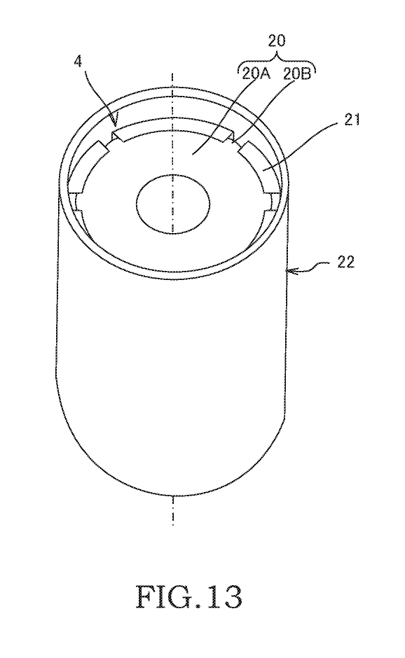

Next, as shown in FIG. 12, the rotor core unit 4 is inserted from an open end of the rotor cover 22 and accommodated in the rotor cover 22. At this stage, since the upper surface portion 24 is not formed, when the rotor core unit 4 is inserted in the rotor cover 22 so as to be in contact with the bottom portion 26, as shown in FIG. 13, the open end of the rotor cover 22 is positioned above an upper end of the rotor core 20.

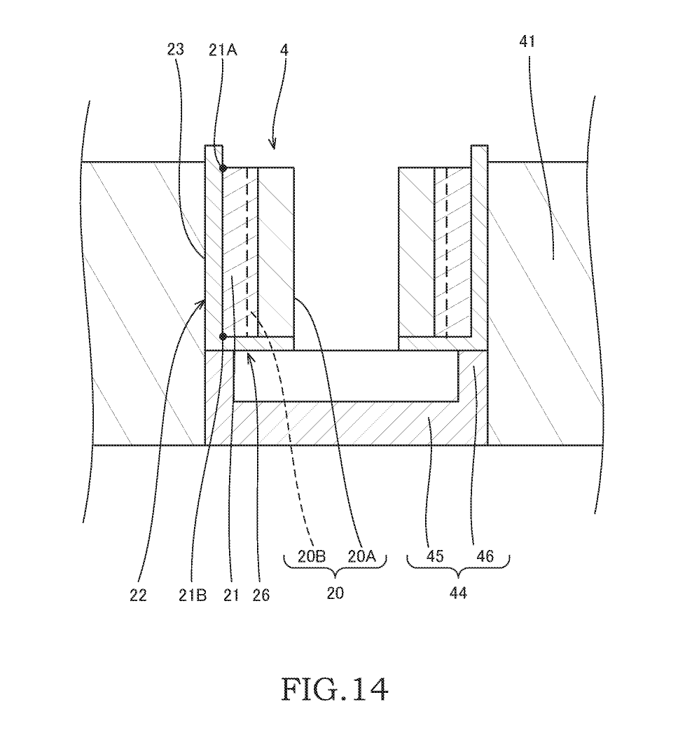

As shown in FIG. 14, the rotor cover 22 accommodating the rotor core unit 4 is inserted in the outer mold 41 from the bottom portion 26 side so as to be placed on the lower die 44. It should be noted that the rotor core unit 4 may be inserted from the open end of the rotor cover 22 and accommodated inside the rotor cover 22 after the rotor cover 22 is accommodated inside the outer mold 41 and placed on the lower die 44.

Next, a pressing process in which the open end of the rotor cover 22 protruding from an end part of the rotor core 20 in the axial direction is pressed radially inward is performed. In the pressing process, the upper surface portion 24 and the bottom portion 26 that hold the rotor core unit 4 in the axial direction are formed on the rotor cover 22.

In the pressing process, the open end of the rotor cover 22 is pressed radially inward by a pressing member while sandwiching the bottom portion 26 of the rotor cover 22 by the lower die 44 and the permanent magnets 21. In the pressing process, the open end of the rotor cover 22 is pressed radially inward by the plurality of the outer collets as the pressing member and the plurality of inner collets as the holding member.

The pressing process includes the first pressing process and the second pressing process. In the first pressing process, an open end of the cylindrical portion 23 is pressed radially inward. In the second pressing process, the open end of the rotor cover 22 that is pressed radially inward in the first pressing process is further pressed radially inward. The first outer collets 42 as the outer collets and the inner collets 43 are used in the first pressing process. The second outer collets 52 are used as the outer collets in the second pressing process. It should be noted that, in this embodiment, although the inner collets 43 are not used in the second pressing process, the process is not limited, and the inner collets 43 may also be used.

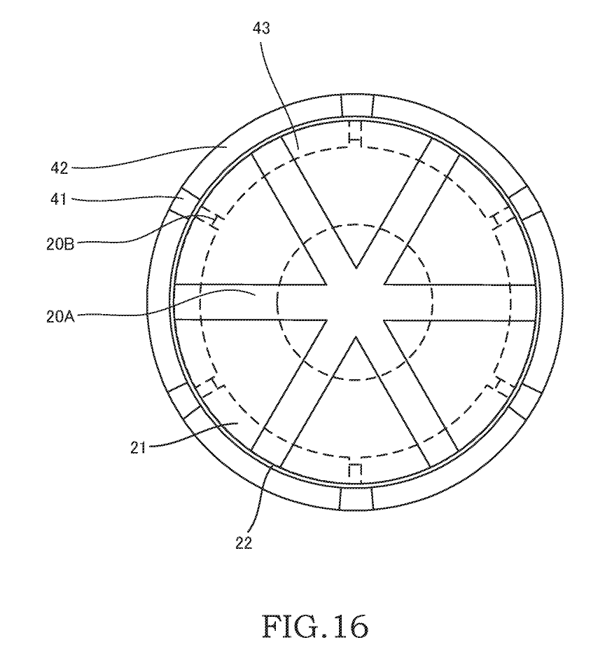

As shown in FIGS. 15 and 16, in the first pressing process, the plurality of the first outer collets 42 that are circumferentially divided are arranged annularly side by side on the upper part of the outer mold 41. The first outer collets 42 are arranged so as to be brought into contact with the outer circumferential surface of the open end of the rotor cover 22 in a state having predetermined gaps in the circumferential direction. The first outer collets 42 are arranged so that the circumferential gaps thereof face the gaps between the permanent magnets 21, respectively, through the rotor cover 22 (see FIG. 16).

In addition, as shown in FIGS. 15 and 16, the plurality of the inner collets 43 that are circumferentially divided are arranged annularly side by side on the upper part of the rotor core 20 and an inner circumferential side of the rotor cover 22. Each of the inner collets 43 is arranged so as to be brought into contact with an inner circumferential surface of the open end of the rotor cover 22 in a state having predetermined gaps in the circumferential direction. The inner collets 43 are arranged so that the circumferential gaps thereof and the gaps between the first outer collets 42 are shifted in the circumferential direction.

Next, the first outer collets 42 are pressed radially inward while the inner collets 43 are pressed radially outward. The first outer collets 42 are pressed radially inward by a pressing force exceeding a pressing force acting on the inner collets 43 toward radially outward. Consequently, the first outer collets 42 moves radially inward, and the open end of the rotor cover 22 is pressed radially inward by the first outer collets 42 in a state being held by the inner collets 43 from the inner circumferential side.

A part of the rotor cover 22 that is pressed radially inward may be simply pulled radially inward or may be stretched radially inward as in a drawing process by the first outer collets 42 and the inner collets 43. Whether the part is pulled or stretched is adjusted depending on the relationship between the pressing forces of the first outer collets 42 and the inner collets 43. In other words, while the pressing forces of the first outer collets 42 and the inner collets 43 are provided to the rotor cover 22 as a wrinkle holding force, the open end of the rotor cover 22 may be bent radially inward so that a thickness thereof is not changed or may be bent so that the thickness is positively reduced by the pressing forces of the first outer collets 42 and the inner collets 43. Wrinkles may be or may not be formed in the portion of the rotor cover 22 that is pressed radially inward by the pulling or stretching.

The first outer collets 42 press the rotor cover 22 not only radially inward, but also axially downward. The axially downward pressing by the first outer collets 42 is performed by the weight of themselves or by an external force that is applied by the pressing auxiliary member 14.

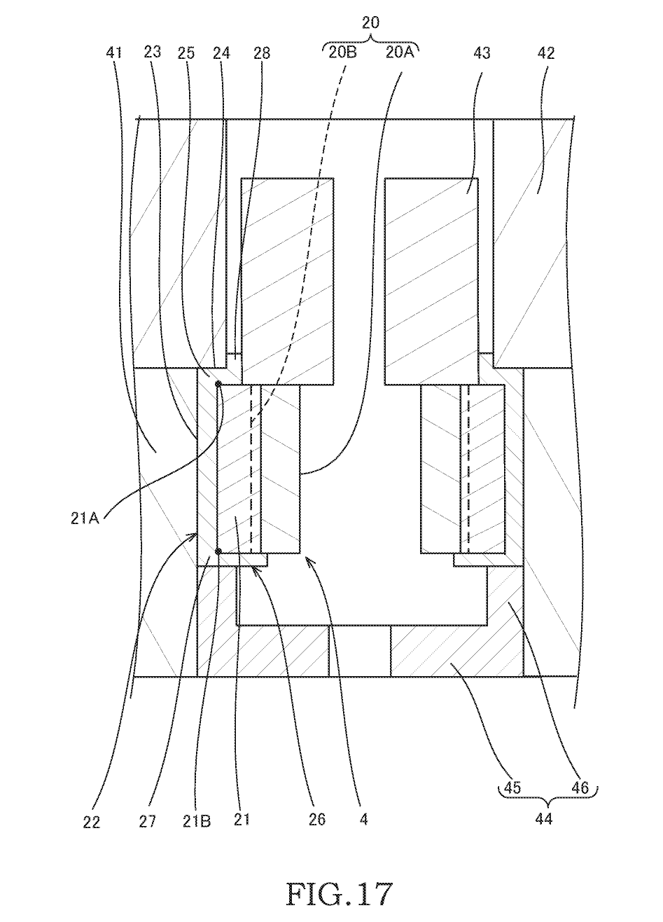

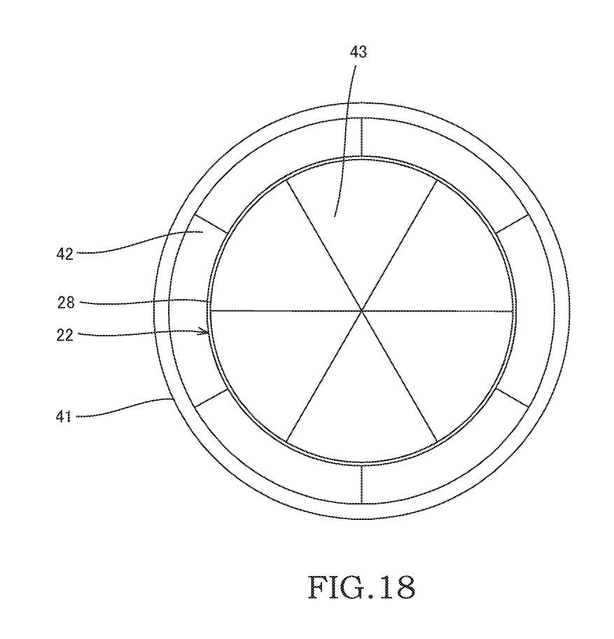

As the first outer collets 42 press the rotor cover 22 radially inward and axially downward, as shown in FIG. 17, the upper surface portion 24 of the rotor cover 22, the permanent magnets 21, and the bottom portion 26 of the rotor cover 22 are held by the first outer collets 42 and the lower die 44. That is, in the first pressing process, while the bottom portion 26 of the rotor cover 22 is held by the lower die 44 and the permanent magnets 21, the open end of the rotor cover 22 is pressed radially inward so that each of gaps between the first outer collets 42 and the inner collets 43 is reduced (see FIG. 18). As a result, the open end of the rotor cover 22 is pressed radially inward relative to the cylindrical portion 23.

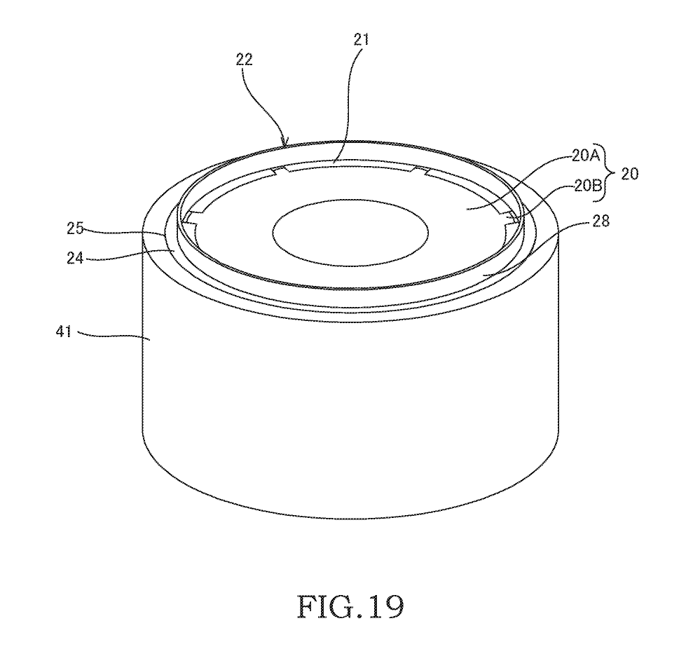

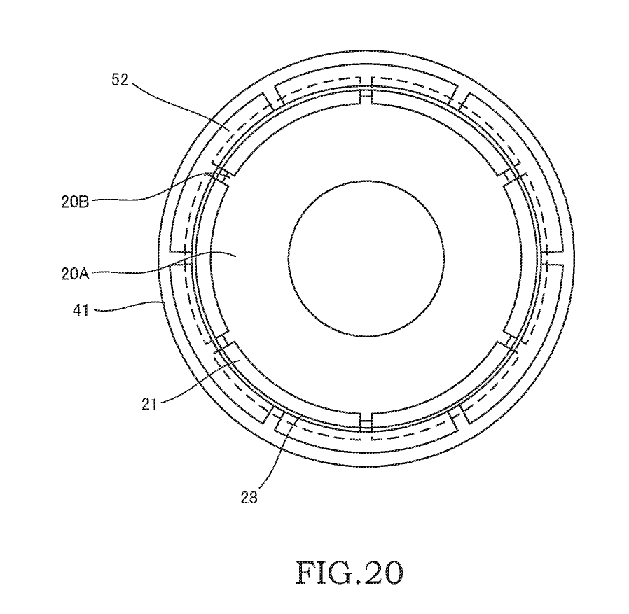

Consequently, as shown in FIGS. 17 and 19, the rotor cover 22 is formed with a part of the upper surface portion 24, a boss portion 28 that has an outer diameter smaller than that of the cylindrical portion 23, and the upper surface corner portion 25 that is in contact with the outer circumferential edge portion 21A positioned on the one axial end surface of the permanent magnets 21. The rotor core unit 4 is held by the upper surface corner portion 25 and the bottom portion 26.

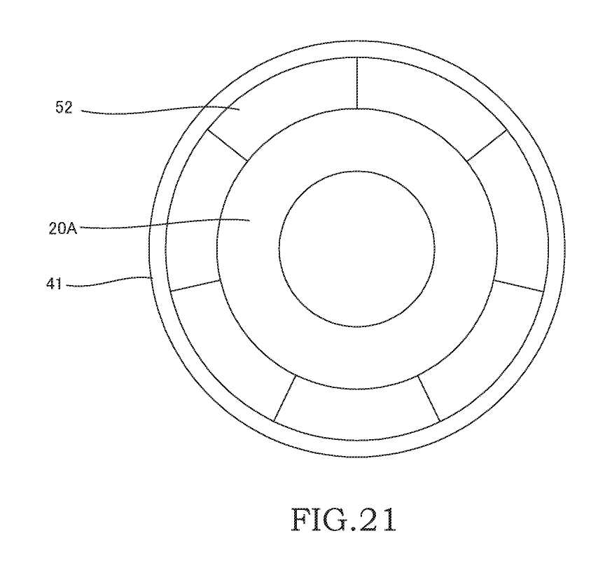

Next, in the second pressing process, as shown in FIG. 20, the second outer collets 52 are arranged on an outer circumferential side of the boss portion 28 that is the open end of the rotor cover 22. The second outer collets 52 are also arranged so that circumferential gaps thereof are shifted in the circumferential direction with respect to the gaps between the permanent magnets 21.

Next, the second outer collets 52 are pressed radially inward. Also in this case, similarly to the first pressing process, a part of the rotor cover 22 that is pressed radially inward may be simply pulled radially inward or may be stretched radially inward as in a drawing process by the second outer collets 52.

The second outer collets 52 press the rotor cover 22 axially downward in addition to radially inward. This can reduce springback occurring after the upper surface portion 24 is finished. Similarly to the first pressing process, the axially downward pressing by the second outer collets 52 is performed by the weight of themselves or by an external force that is applied by the pressing auxiliary member 14.

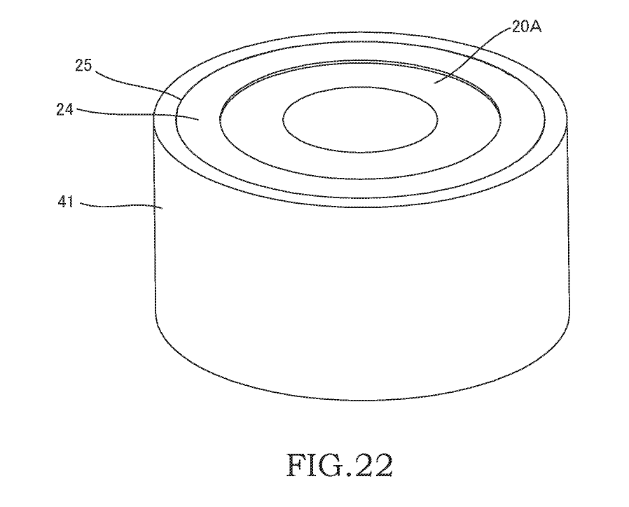

As shown in FIG. 21, the boss portion 28 of the rotor cover 22 is pressed radially inward so that each of gaps between the second outer collets 52 is eliminated. As shown in FIG. 22, as the second outer collets 52 are removed, the boss portion 28 of the rotor cover 22 is further pressed radially inward, and the upper surface portion 24 is formed on the rotor cover 22. Consequently, the rotor core unit 4 is held in the axial direction by the entire upper surface portion 24 including the upper surface corner portion 25 and the bottom portion 26.

When the pressing process as mentioned above is completed, the outer mold 41 is removed, and the shaft 1 is inserted into the center of the rotor core 20. As a result, the rotor 2 having the shaft 1 is completed as shown in FIG. 2.

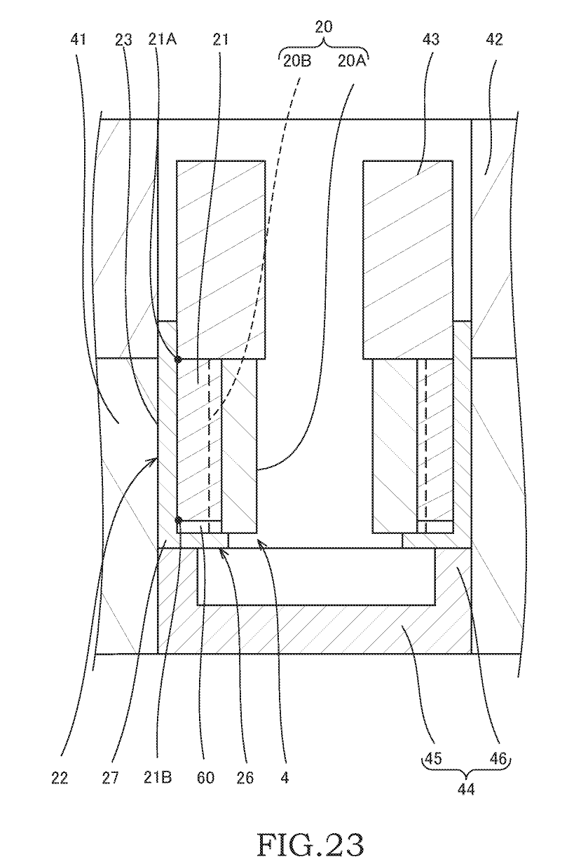

Next, with reference to FIGS. 23 to 26, the following describes the pressing process in the case in which the axial length of the rotor core 20 is longer than those of the permanent magnets 21. In the case in which the axial length of the rotor core 20 is longer than those of the permanent magnets 21, the bottom portion 26 and the recessed portions 122 are formed in the pressing process in addition to the upper surface portion 24 having the upper surface corner portion 25. The bottom portion 26 has the core contact portion 120 that is in contact with the bottom surface of the rotor core 20 and the connecting portion 121 that connects the core contact portion 120 to the bottom corner portion 27. The recessed portions 122 are depressed at an inner side in the axial direction thereof along one axial end part of the protruding portion 20C of the rotor core 20 so as to cover one end portion of the rotor core 20.

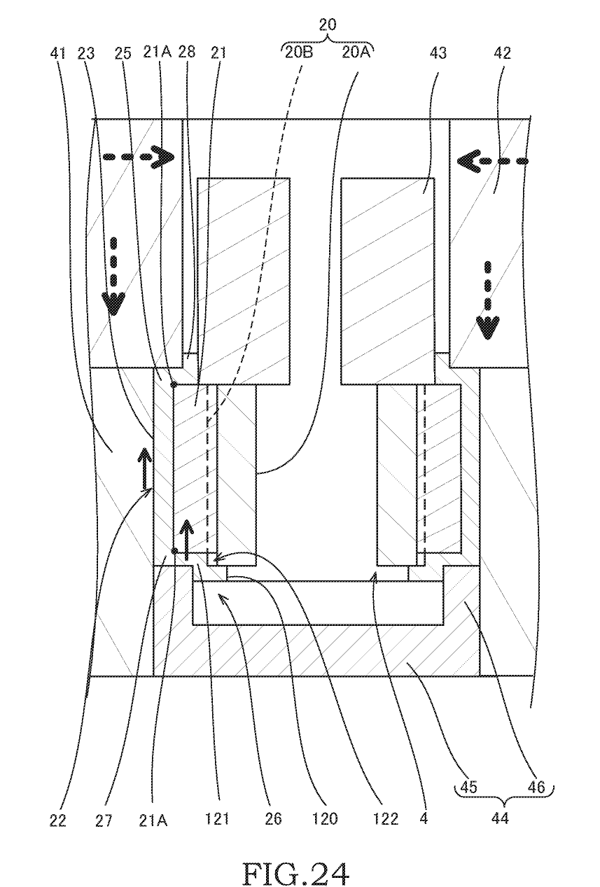

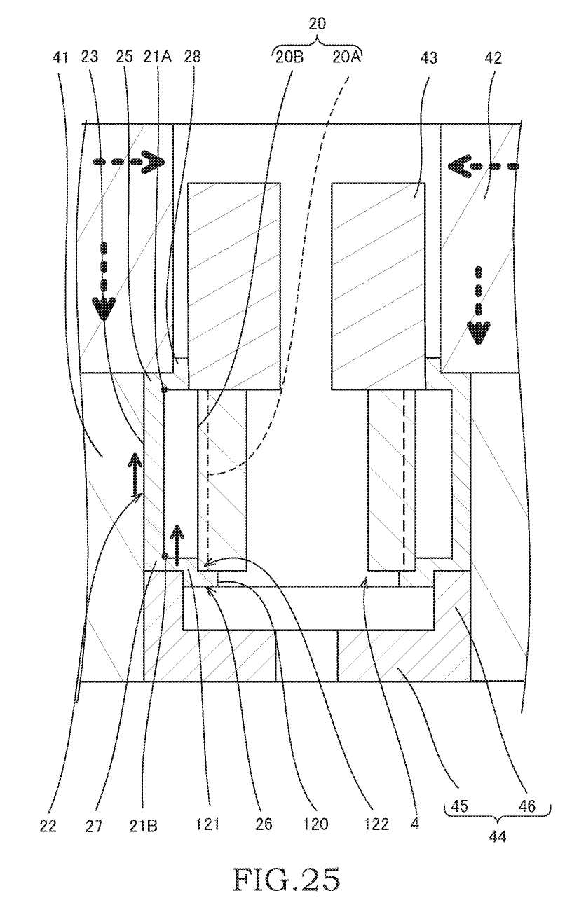

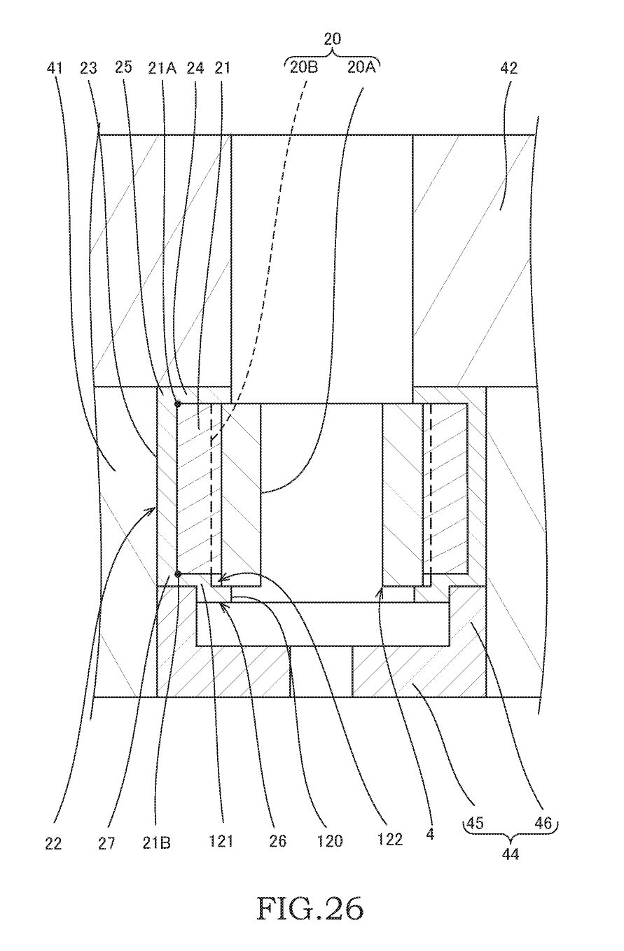

FIGS. 23 to 26 illustrate the pressing process in a case in which the axial length of the rotor core 20 is longer than those of the permanent magnets 21. FIG. 23 is a view illustrating a state before the upper surface portion 24 is formed by the pressing process and is a cross-sectional view (corresponding to A-A cross-section of FIG. 1) that includes only the center part 20A of the rotor core 20. FIGS. 24 and 25 illustrate the first pressing process. FIG. 24 illustrates the cross-section (corresponding to A-A cross-section of FIG. 1) that includes only the center part 20A of the rotor core 20. FIG. 25 illustrates the cross-section (corresponding to B-B cross-section of FIG. 1) that includes the center part 20A and the projecting portions 20B of the rotor core 20. FIG. 26 is a view illustrating the second pressing process and illustrates the cross-section (corresponding to A-A cross-section of FIG. 1) that includes only the center part 20A of the rotor core 20. FIGS. 23, 24 and 26 schematically indicate the projecting portions 20B of the rotor core 20 by broken lines. FIG. 25 schematically indicates the center part 20A of the rotor core 20 and the permanent magnets 21 by broken lines.

In a case in which the axial length of the rotor core 20 is longer than those of the permanent magnets 21, when the rotor core 20 that is mounted with the permanent magnets 21 is accommodated in the rotor cover 22 before forming the upper surface portion 24, as shown in FIG. 23, the axial direction gap 60 is formed between the permanent magnets 21 and the bottom portion 26 of the rotor cover 22.

In the first pressing process, the first outer collets 42 press the rotor cover 22 axially downward and radially inward as indicated by broken arrows in FIG. 24. Consequently, as indicated by solid arrows in FIG. 24, the cylindrical portion 23 is pulled upward, and a part of the bottom portion 26 of the rotor cover 22 that is in contact with the contact portion 46 of the lower die 44 is deformed by being sandwiched between the permanent magnets 21 and the contact portion 46. Specifically, a part of an outer circumference of the bottom portion 26 of the rotor cover 22 that is in contact with the contact portion 46 is deformed to eliminate the axial direction gap 60 between the permanent magnets 21 so as to be in contact with the bottom surfaces of the permanent magnets 21. As a result, the upper surface portion 24 of the rotor cover 22, the bottom portion 26, and the permanent magnets 21 are sandwiched by the first outer collets 42 and the lower die 44.

The part of the outer circumference of the bottom portion 26 of the rotor cover 22 can easily be deformed by the contact portion 46 of the lower die 44, and thereby, a processing force required for deforming the rotor cover 22 can be reduced.

In the first pressing process, an upward pulling force is applied to a center side of the bottom portion 26 of the rotor cover 22 at the same time that the outer circumference of the bottom portion 26 of the rotor cover 22 is deformed. Thus, as shown in FIG. 25, the center side of the bottom portion 26 of the rotor cover 22 is deformed along the axial direction one end portion of the projecting portions 20B of the rotor core 20, that is, along the outer circumferential edge portion of the protruding portion 20C. As a result, the core contact portion 120 that is in contact with the rotor core 20, the recessed portions 122 along an outer circumferential edge portion of the protruding portion 20C, and the connecting portion 121 that connects the core contact portion 120 to the bottom corner portion 27 are formed.

In the second pressing process, as shown in FIG. 26, the boss portion 28 that is formed in the first pressing process is further pressed radially inward, and the upper surface portion 24 is formed.

In this way, in a case in which the axial length of the rotor core 20 is longer than those of the permanent magnets 21, the core contact portion 120, the connecting portion 121, and the recessed portions 122 are further formed in addition to the upper surface portion 24 having the upper surface corner portion 25 that is in contact with an outer circumferential edge portion 21A that is positioned on the one axial end surface of the permanent magnet 21.

On the other hand, in a case in which the axial length of the rotor core 20 is shorter than those of permanent magnets 21, similarly to the case in which the axial length of the rotor core 20 is equal to those of permanent magnets 21, when the rotor core 20 that is mounted with the permanent magnets 21 is accommodated in the rotor cover 22, the bottom portion 26 of the rotor cover 22 is in contact with the permanent magnets 21. In this case, the axial direction gap 60 is not formed between the bottom portion 26 of the rotor cover 22 and the permanent magnets 21. Therefore, in the first pressing process, the upper surface portion 24 of the rotor cover 22, the bottom portion 26, and the permanent magnets 21 are securely held by the first outer collets and the lower die 44 without causing deformation of the bottom portion 26 of the rotor cover 22. Thus, the first holding portion and the second holding portion, i.e. the upper surface portion 24 having the upper surface corner portion 25 and the bottom portion 26, that hold the rotor core unit 4 in the axial direction are formed reliably.

In the method of manufacturing the rotor 2 according to the present embodiment as described above, the rotor cover 22 is formed with the upper surface portion 24 and the bottom portion 26 regardless of the magnitudinal relationship of the axial lengths between the rotor core 20 and the permanent magnets 21. The upper surface portion 24 has the upper surface corner portion 25 that is in contact with the outer circumferential edge portion 21A positioned on the one axial end surface of the permanent magnets 21. The bottom portion 26 is in contact with at least one of the other end surfaces of the rotor core 20 and the permanent magnets 21 of the rotor core unit 4 so as to hold the rotor core unit 4 with the upper surface portion 24 in the axial direction. In other words, even if axial lengths of the rotor core 20 and the permanent magnets 21 are varied within a range of dimensional tolerance so that the magnitudinal relationship of the axial lengths therebetween is different, the rotor core unit 4 can be securely held by the upper surface portion 24 and the bottom portion 26. Therefore, regardless of the magnitudinal relationship of the axial lengths between the rotor core 20 and the permanent magnets 21, a rotation of the rotor cover 22 can be restricted.

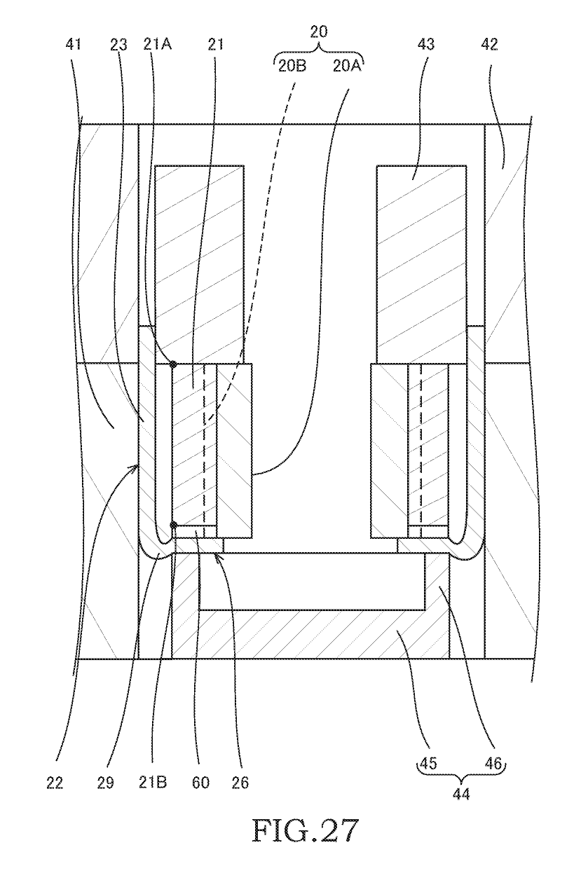

Next, a modification of the present embodiment will be described with reference to FIG. 27.

As shown in FIG. 27, the bottom portion 26 of the rotor cover 22 may be provided with a surplus material portion 29 that is separated from the outer circumferential edge portion 21B of the permanent magnet 21 before the upper surface portion 24 is formed (before the pressing process). When the upper surface portion 24 is formed in the pressing process, the surplus material portion 29 that is provided on the rotor cover 22 before the pressing process can increase a radial length of the upper surface portion 24 of the rotor cover 22 while suppressing a reduction of wall thickness. This can securely cover the permanent magnets 21.

In the above-mentioned modification, when the axial length of the rotor core 20 is longer than those of the permanent magnets 21, the axial direction gap 60 becomes large because of the surplus material portion 29. However, in the method of manufacturing the rotor 2 and the rotor manufacturing apparatus according to the present embodiment, even when the surplus material portion 29 is provided, because the bottom portion 26 of the rotor cover 22 is deformed by the contact portion 46 of the lower die 44 so as to eliminate the axial direction gap 60, the rotor cover 22 as shown in FIG. 24 can be formed. Therefore, even when the surplus material portion 29 is provided, a rotation of the rotor cover 22 can be restricted by holding the rotor core unit 4 in the axial direction by the upper surface portion 24 and the bottom portion 26.

In the above embodiment, a description is given for a case in which, when the axial length of the rotor core 20 is longer than those of the permanent magnets 21, the rotor core unit 4 is accommodated in the rotor cover 22 so that the protruding portion 20C faces the bottom portion 26. Alternatively, the rotor core unit 4 may be accommodated in the rotor cover 22 so that the protruding portion 20C is positioned at upper part forming the upper surface portion 24 is formed, in other words, so that the protruding portion 20C faces the open end of the rotor cover 22 before the upper surface portion 24 is formed. Even in this case, the upper surface corner portion 25 that is in contact with the outer circumferential edge portion 21A positioned on the one axial end surface of the permanent magnet 21 can be reliably formed by pressing the end part of the rotor cover 22 radially inward in the first pressing process.

The above embodiment achieves the following effects.

The rotor core unit 4 of the rotor 2 is held in the axial direction by the upper surface portion 24 that has the upper surface corner portion 25 being in contact with the outer circumferential edge portion 21A positioned on the one axial end surface of the permanent magnet 21 and the bottom portion 26 that is in contact with at least one of the other end surfaces of the rotor core 20 and the permanent magnet 21. It is possible to restrict the circumferential relative rotation between the rotor core unit 4 and the rotor cover 22 by the frictional force therebetween. Therefore, the rotation of the rotor cover 22 can easily be restricted.

The bottom portion 26 of the rotor cover 22 in the rotor 2 is provided with the recessed portions 122 that are formed along a shape of an one end part of the projecting portions 20B constituting the protruding portion 20C and that covers the one end part. Because the part of the projecting portions 20B constituting the protruding portion 20C of the rotor core 20 is accommodated in the recessed portions 122 of the rotor cover 22, the projecting portions 20B are engaged with the recessed portions 122 so as to restrict a circumferential relative rotation between the rotor core 20 and the rotor cover 22. In this way, in a case in which the axial length of the rotor core 20 is longer than those of the permanent magnets 21, the rotor core unit 4 is held by the upper surface portion 24 and the bottom portion 26. In addition, the projecting portions 20B are engaged with the recessed portions 122. Therefore, it is possible to restrict the rotation of the rotor cover 22 more securely.

In the method of manufacturing the rotor 2 according to the present embodiment, the rotor cover 22 is formed with the upper surface portion 24 and the bottom portion 26 regardless of the magnitudinal relationship of the axial lengths between the rotor core 20 and the permanent magnet 21. The upper surface portion 24 has the upper surface corner portion 25 that is in contact with the outer circumferential edge portion 21A positioned on the one axial end surface of the permanent magnet 21. The bottom portion 26 is in contact with at least one of the other end surfaces of the rotor core 20 and the permanent magnet 21 so as to hold the rotor core unit 4 with the upper surface portion 24 in the axial direction. Therefore, in the method of manufacturing the rotor 2 according to the present embodiment, the rotor 2 that has the rotor cover 22 the rotation of which is restricted can be manufactured by the same manufacturing method regardless of the magnitudinal relationship of the axial lengths between the rotor core 20 and the permanent magnet 21.

In the method of manufacturing the rotor 2 according to the present embodiment, the open end of the rotor cover 22 is pressed radially inward while being pressed by the first outer collets 42 (the second outer collets 52) in the axial direction toward the rotor core 20. Consequently, the permanent magnets 21 and the rotor cover 22 can be securely held by the first outer collets 42 (the second outer collets 52) and the lower die 44. Therefore, the upper surface portion 24 and the bottom portion 26 that hold the rotor core unit 4 in the axial direction are formed reliably, and thereby, the rotation of the rotor cover 22 can be restricted more securely.

In the method of manufacturing the rotor 2 according to the present embodiment, when the axial length of the rotor core 20 is longer than those of the permanent magnets 21, the recessed portions 122 is formed in addition to the upper surface portion 24 and the bottom portion 26 that hold the rotor core unit 4. The recessed portions 122 are depressed at an inner side in the axial direction along the outer circumferential edge portion that is positioned on one axial end part of the projecting portions 20B constituting the protruding portion 20C of the rotor core 20. Because the recessed portions 122 that cover the outer circumferential edge portion of the projecting portions 20B constituting the protruding portion 20C are formed, the projecting portions 20B of the rotor core 20 engage with the recessed portions 122 so as to restrict the circumferential relative rotation between the rotor core 20 and the rotor cover 22. Therefore, even when the axial length of the rotor core 20 is longer than those of the permanent magnets 21, the rotation of the rotor cover 22 can be more securely restricted.

In the rotor manufacturing apparatus 10 according to the present embodiment, the lower die 44 includes the annular contact portion 46 that supports the one axial end surfaces of the permanent magnets 21 through the bottom portion 26 of the rotor cover 22. Even when the axial length of the rotor core 20 is longer than those of the permanent magnets 21, the bottom portion 26 of the rotor core 20 can be securely held by the permanent magnets 21 and the lower die 44. Therefore, the recessed portions 122 can be reliably formed on the bottom portion 26 so as to restrict the rotation of the rotor cover 22 more securely.

Because the part of an outer circumference of the bottom portion 26 of the rotor cover 22 can easily be deformed by the contact portion 46 of the lower die 44, the processing force can be reduced. Therefore, with the rotor manufacturing apparatus 10, it is possible to prevent the increase in size.

Hereinafter, configurations, functions, and effects of the embodiments of the present invention are summarized.

The rotor 2 includes the rotor core unit 4 and the single cylindrical rotor cover 22. The rotor core unit 4 has the rotor core 20 fixed to the shaft 1 so as to be able to rotate integrally therewith, and the plurality of permanent magnets 21 mounted on the rotor core 20 along the circumferential direction thereof. The single cylindrical rotor cover 22 covers an outer circumference of the rotor core 20. The single cylindrical rotor cover 22 has the upper surface portion 24 that is in contact with an outer circumferential edge portion 21A part positioned on one end surface in an axial direction of the permanent magnets 21, and the bottom portion 26 that is in contact with at least one of the other end surfaces of the permanent magnets 21 and the rotor core 20 so that the rotor core unit 4 is held in the axial direction by the upper surface portion 24 and the bottom portion 26.

In this configuration, because the rotor core unit 4 is held in the axial direction by the upper surface portion 24 and the bottom portion 26, the circumferential relative rotation between the rotor cover 22 and the rotor core unit 4 is restricted by the frictional force between the outer circumferential edge portion 21A and the upper surface corner portion 25 of the upper surface portion 24 and by the frictional force between the bottom portion 26 and at least one of the other end surfaces of the rotor core 20 and the permanent magnets 21. Therefore, the rotation of the rotor cover 22 can be restricted more easily.

In the rotor 2, the rotor core 20 has the protruding portion 20C that protrudes further in the axial direction than the other end surfaces of the permanent magnets 21, and the bottom portion 26 of the rotor cover 22 facing the other end surfaces of the permanent magnets 21 is provided with the recessed portions 122 that are in contact with the outer circumferential edge portion of the protruding portion 20C.

In the rotor 2, the rotor core 20 has the center part 20A and the plurality of projecting portions 20B. The center part 20A is provided on an inside of the plurality of permanent magnets 21. The plurality of projecting portions 20B project radially outward from the center part 20A so as to be respectively provided between the adjacent permanent magnets 21. The recessed portions 122 are in contact with outer circumferential edge portions of the projecting portions 20B.

In this configuration, because the projecting portions 20B that constitute the protruding portion 20C of the rotor core 20 are accommodated in the recessed portions 122 of the rotor cover 22, the projecting portions 20B constituting the protruding portion 20C are engaged with the recessed portions 122 and the circumferential relative rotation between the rotor core unit 4 and the rotor cover 22 is restricted. Therefore, it is possible to restrict the rotation of the rotor cover 22 more securely.

The rotary electric machine 100 includes the rotor 2 that includes the above-mentioned configuration.

In the method of manufacturing the rotor 2 according to the embodiment of the present invention, the rotor 2 that includes the rotor core unit 4 is manufactured. The rotor core unit 4 includes the rotor core 20 that is fixed to the shaft 1 so as to be able to rotate integrally therewith and the plurality of permanent magnets 21 mounted on the rotor core 20 along the circumferential direction thereof. The method of manufacturing the rotor 2 includes a placing process in which the cylindrical rotor cover 22 having the bottom portion 26 is placed on the lower die 44, an accommodating process in which the rotor core unit 4 is accommodated in the rotor cover 22, and the pressing process in which the upper surface portion 24 and the bottom portion 26 are formed on the rotor cover 22 by pressing the open end of the rotor cover 22, which protrudes from the end part of the rotor core 20 in the axial direction, radially inward by the outer collets (the first outer collets 42, the second outer collets 52) while holding the bottom portion 26 of the rotor cover 22 by the lower die 44 and the permanent magnets 21. The upper surface portion 24 is in contact with the outer circumferential edge portion 21A of the one axial end surfaces of the permanent magnets 21. The bottom portion 26 is in contact with at least one of the other end surfaces of the permanent magnets 21 and the rotor core 20 so that the rotor core unit 4 is held in the axial direction by the upper surface portion 24 and the bottom portion 26.

In this configuration, the open end of the rotor cover 22 is pressed radially inward by the outer collets (the first outer collets 42, the second outer collets 52) while holding the bottom portion 26 of the rotor cover 22 by the lower die 44 and the permanent magnets 21. In this way, the upper surface portion 24 and the bottom portion 26 that hold the rotor core unit 4 in the axial direction are formed on the rotor cover 22. The outer circumferential edge portions 21A, 21B that are positioned on the both axial end surfaces of the permanent magnets 21 are held in the axial direction by the bottom corner portion 27 and the upper surface corner portion 25 of the rotor cover 22, respectively. Therefore, the frictional force between the outer circumferential edge portion 21A and the upper surface corner portion 25 of the upper surface portion 24, and the frictional force between at least one of the rotor core 20 and the permanent magnets 21 and the bottom portion 26 can restrict the circumferential relative rotation between the rotor core unit 4 and the rotor cover 22. As a result, it is possible to easily restrict the rotation of the rotor cover 22.

With the method of manufacturing the rotor 2 according to the present invention, in the pressing process of forming the upper surface portion 24 and the bottom portion 26, the upper surface portion 24 and the bottom portion 26 are formed by pressing the open end of the rotor cover 22 radially inward while pressing the outer collets (the first outer collets 42, the second outer collets 52) toward the rotor core 20 in the axial direction and by pressing the permanent magnets 21 and the rotor cover 22 in the axial direction in a state being sandwiched by the outer collets (the first outer collets 42, the second outer collets 52) and the lower die 44.

In this configuration, the rotor core unit 4 can easily be held by the rotor cover 22 by pressing the outer collets (the first outer collets 42, the second outer collets 52) in the axial direction, and the upper surface portion 24 and the bottom portion 26 can easily be formed.

The rotor manufacturing apparatus 10 manufactures the rotor 2 that includes the rotor core unit 4 having a rotor core 20 fixed to the shaft 1 so as to be able to rotate integrally therewith and the plurality of permanent magnets 21 mounted on the rotor core 20 along a circumferential direction thereof. The rotor manufacturing apparatus 10 includes the outer collets (the first outer collets 42, the second outer collets 52) and the lower die 44. The outer collets press the open end of the rotor cover 22 radially inward that protrudes toward the axial direction from the end part of the rotor core 20. The lower die 44 supports the bottomed cylindrical rotor cover 22 accommodating the rotor core unit 4 placed thereon and sandwiches the bottom portion 26 of the rotor cover 22 with the permanent magnets 21. The rotor cover 22 is formed with the upper surface portion 24 and the bottom portion 26 by the outer collets (the first outer collets 42, the second outer collets 52) and the lower die 44. The upper surface portion 24 is in contact with an outer circumferential edge portion 21A that is positioned on the one end surface in an axial direction of the permanent magnet 21. The bottom portion 26 is in contact with at least one of the other end surface of the permanent magnet 21 and the rotor core 20 so that the rotor core unit 4 is held in the axial direction by the upper surface portion 24 and the bottom portion 26.

In this configuration, the upper surface portion 24 and the bottom portion 26 that hold the rotor core unit 4 in the axial direction are formed on the rotor cover 22 by the outer collets (the first outer collets 42, the second outer collets 52) and the lower die 44. The outer collets press the open end of the rotor cover 22. The lower die 44 sandwiches the bottom portion 26 of the rotor cover 22 between the permanent magnets 21 and the lower die 44. The rotor core unit 4 is held in the axial direction by the upper surface portion 24 and the bottom portion 26 the rotor cover 22. Therefore, the frictional force between the outer circumferential edge portion 21A and the upper surface corner portion 25 of the upper surface portion 24, and the frictional force between at least one of the rotor core 20 and the permanent magnets 21 and the bottom portion 26 can restrict the circumferential relative rotation between the rotor core unit 4 and the rotor cover 22. As a result, it is possible to easily restrict the rotation of the rotor cover 22.

The lower die 44 of the rotor manufacturing apparatus 10 includes the annular contact portion 46 that is in contact with the bottom portion 26 of the rotor cover 22 to be placed so as to support the one axial end surfaces of the permanent magnets 21 through the bottom portion 26 of the rotor cover 22.

In this configuration, since the lower die 44 includes the contact portion 46, the bottom portion 26 of the rotor cover 22 can be securely held by the lower die 44 and the permanent magnets 21. Therefore, the upper surface portion 24 and the bottom portion 26 can easily be formed, and thereby, the rotation of the rotor cover 22 can be restricted more securely.

The embodiments of the present invention described above are merely illustration of some application examples of the present invention and not of the nature to limit the technical scope of the present invention to the specific constructions of the above embodiments.

Although the upper surface portion 24 of the rotor cover 22 extends radially inward to cover and hide the permanent magnets 21, the upper surface portion 24 may extend such that the permanent magnets 21 is partially exposed.

In the above embodiment, when forming the upper surface portion 24 of the rotor cover 22, the outer mold 41 is disposed to surround the entire outer circumference of the cylindrical portion 23. Alternatively, the outer mold 41 may be disposed to surround a part of the outer circumference of the cylindrical portion 23, or it may not be used.

In the above embodiment, the upper surface portion 24 is gradually formed through two processes of the first pressing process and the second pressing process. Alternatively, the upper surface portion 24 may be formed by pressing the open end of the rotor cover 22 radially inward through three or more processes.

In the above embodiment, when the axial length of the rotor core 20 is longer than those of the permanent magnets 21, the bottom corner portion 27 is formed on the rotor cover 22 by the first pressing process. Alternatively, the bottom corner portion 27 may be formed gradually by a plurality of pressing processes, for example, two processes of the first pressing process and the second pressing process.

In the above embodiment, the upper surface portion 24 is formed by using the first outer collets 42 and the inner collets 43 in the first pressing process. Alternatively, the upper surface portion 24 may be formed by using only the first outer collets 42 without using the inner collets 43 in the same way as the second pressing process.

In the above embodiment, although the rotor cover 22 is described to be made of non-magnetic stainless steel, the rotor cover 22 may be made of other non-magnetic materials such as aluminum etc.

In the above embodiment, the rotor manufacturing apparatus 10 may include an inner auxiliary member (not shown) that defines the axial positions of the inner collets 43 with respect to the rotor core 20. Consequently, it is possible to prevent the lifting of the inner collets 43 causing separation of the inner collets 43 from the rotor core 20 in the axial direction, and to hold the rotor cover 22 by the first outer collets 42 and the inner collets 43 with a stable holding force.

The present application claims a priority based on Japanese Patent Application No. 2015-144214 filed with the Japan Patent Office on Jul. 21, 2015, all the contents of which are hereby incorporated by reference.

1. A rotor comprising:
a rotor core unit having a rotor core fixed to a rotation axis so as to be able to rotate integrally therewith and a plurality of permanent magnets mounted on the rotor core along a circumferential direction thereof; and
a single cylindrical rotor cover having a first holding portion and a second holding portion so as to cover an outer circumference of the rotor core, the first holding portion being in contact with an outer circumferential edge portion positioned on one end surface in an axial direction of the permanent magnet, the second holding portion being in contact with at least one of another end surface of the permanent magnet and the rotor core so that the rotor core unit is held in the axial direction by the first holding portion and the second holding portion wherein
the rotor core has a protruding portion protruding further in the axial direction than the another end surface of the permanent magnet, and
a bottom portion of the rotor cover facing the another end surface of the permanent magnet is provided with a recessed portion formed so that an inner side in the axial direction of the rotor cover is recessed along an outer circumferential edge portion of the protruding portion, the recessed portion being in contact with the outer circumferential edge portion of the protruding portion.

2. (canceled)

3. The rotor according to claim 1, wherein
the rotor core has a center part and a plurality of projecting portions,
the center part being provided inside the plurality of permanent magnets,
the plurality of projecting portions being configured to project toward outside in a radial direction from the center part so as to be respectively provided between the adjacent permanent magnets, and
the recessed portion is in contact with the outer circumferential edge portion of the projecting portion.

4. A rotary electric machine comprising the rotor according to claim 1.

5. A method of manufacturing rotor including a rotor core unit having a rotor core fixed to a rotation axis so as to be able to rotate integrally therewith and a plurality of permanent magnets mounted on the rotor core along a circumferential direction thereof, comprising
placing a cylindrical rotor cover having a bottom portion on a lower die,
accommodating the rotor core unit in the rotor cover, and
forming a first holding portion and a second holding portion on the rotor cover by pressing an open end of the rotor cover radially inward by a pressing member while holding the bottom portion of the rotor cover between the lower die and the permanent magnets, the open end of the rotor cover being configured to protrude toward an axial direction from an end part of the rotor core, the first holding portion being in contact with an outer circumferential edge portion of one end surface in the axial direction of the permanent magnet, the second holding portion being in contact with at least the permanent magnet and the rotor core so that the rotor core unit is held in the axial direction by the first holding portion and the second holding portion.

6. The method of manufacturing rotor according to claim 5, wherein
in the forming a first holding portion and a second holding portion, the first holding portion and the second holding portion are formed by pressing the open end of the rotor cover radially inward while pressing the pressing member toward the rotor core in the axial direction so that the permanent magnets and the rotor cover are pressed in the axial direction in a state being sandwiched between the pressing member and the lower die.

7. A rotor manufacturing apparatus for manufacturing a rotor including a rotor core unit having a rotor core fixed to a rotation axis so as to be able to rotate integrally therewith and a plurality of permanent magnets mounted on the rotor core along a circumferential direction thereof comprising;
a pressing member configured to press an open end of the rotor cover radially inward, the rotor cover being configured to protrude toward an axial direction from an end part of the rotor core; and
a lower die on which a bottomed cylindrical rotor cover accommodating the rotor core unit is placed so that a bottom portion of the rotor cover is sandwiched between the permanent magnets and the lower die; wherein
the first holding portion and the second holding portion are formed on the rotor cover by the pressing member and the lower die, the first holding portion being in contact with an outer circumferential edge portion of one end surface in the axial direction of the permanent magnet, the second holding portion being in contact with at least one of another end surface of the permanent magnet and the rotor core so that the rotor core unit is held in the axial direction by the first holding portion and the second holding portion.

8. The rotor manufacturing apparatus according to claim 7, wherein
the lower die has an annular contacting part configured to be in contact with the bottom portion of the rotor cover to be placed and to support one end surface in the axial direction of the permanent magnet through the bottom portion of the rotor cover.
